(19) United States
(12) Patent Application Publication
(10) Pub. No.: US 2016/0159011 A1
(43) Pub. Date: Jun. 9, 2016

(54) Vision System for Selective Tridimensional Repair Using Additive Manufacturing

(71) Applicant: Caterpillar Inc., Peoria, IL (US)

(72) Inventors: Thierry A. Marchione, Heber City, UT (US); Matthew T. West, Washington, IL (US); John A. Sherman, Peoria, IL (US)

(73) Assignee: Caterpillar Inc., Peoria, IL (US)

(21) Appl. No.: 14/560,877

(22) Filed: Dec. 4, 2014

(51) Int. Cl. B29C 67/00; G05B 19/4099

(52) U.S. Cl. CPC B29C 67/0088; G05B 19/4099; G05B 2219/35134; B33Y 50/02

(57) ABSTRACT

A computer-implemented method for selective tridimensional repair of a worn surface using at least a scanning device and an additive manufacturing device is provided. The computer-implemented method may include generating a worn surface model of the worn surface based on point cloud data obtained from the scanning device, superimposing the worn surface model onto a nominal surface model, generating trace data corresponding to dimensional variations between the worn surface model and the nominal surface model, and generating a rebuild volume based on the trace data.

### TECHNICAL FIELD

The present disclosure relates generally to localized remanufacturing operations, and more particularly, to vision-based systems and methods for providing tridimensional repair of worn surfaces using additive manufacturing.

### BACKGROUND

Remanufacturing operations are generally used to repair worn surfaces of parts or components with enough salvageable material to justify the repair over the alternative of replacing the part or component as a whole. The remanufacture of worn surfaces is typically performed using one of two conventional approaches. The first approach implements a global overhaul of the entire affected surface irrespective of the specific nature of the wear. By its very nature, this approach often applies not only the affected surfaces but also to unaffected surfaces which may not necessarily need repair. Because the global approach is not customized or specific to the character of the wear, it involves minimal planning or analysis prior to the remanufacturing process. However, in order to ensure that the entire surface is adequately repaired, the remanufacturing process itself tends to be more extensive, time-consuming and costly to perform. Even then, the remanufacturing process often introduces additional defects and is susceptible to other imperfections.

In contrast, the second approach uses a more selective and localized means of remanufacturing a worn surface. Specifically, this approach first identifies the dimension and/or location of the local wear, and performs the repair to only the affected areas. The selective approach thereby saves time and costs in terms of the actual remanufacturing that is performed. However, the process of identifying and digitalizing the localized wear may require sophisticated equipment and time-consuming analyses. Furthermore, the process of providing the actual machine instructions for performing the selective repairs can be tedious and overly burdensome to accomplish using conventionally available equipment and existing technologies. In U.S. Pat. No. 8,442,665 (“Krause”), for example, systems and methods are disclosed which scan a three-dimensional object, calculate a nominal surface location and contour for the object, scan the non-conforming region of the object, calculate a material removal tool path, generate a solid model of the damaged region of the object, and compute a material addition tool path. Krause thus demands several complex iterations of both analysis and machining steps in order to sufficiently remanufacture a single part or component.

In view of the foregoing inefficiencies and disadvantages associated with conventionally available remanufacturing systems and methods, a need therefore exists for more intuitive, efficient and simplified means for providing selective three-dimensional repair of worn surfaces.

### SUMMARY OF THE DISCLOSURE

In one aspect of the present disclosure, a computer-implemented method for selective tridimensional repair of a worn surface using at least a scanning device and an additive manufacturing device is provided. The computer-implemented method may include generating a worn surface model of the worn surface based on point cloud data obtained from the scanning device, superimposing the worn surface model onto a nominal surface model, generating trace data corresponding to dimensional variations between the worn surface model and the nominal surface model, and generating a rebuild volume based on the trace data.

In another aspect of the present disclosure, a control system for selective tridimensional repair of a worn surface is provided. The control system may include a scanning device configured to scan the worn surface, an additive manufacturing device configured to repair the worn surface, a memory configured to retrievably store one or more algorithms, and a controller in communication with each of the scanning device, the additive manufacturing device, and the memory. The controller, based on the one or more algorithms, being configured to at least superimpose a worn surface model of the worn surface onto a nominal surface model, generate trace data corresponding to dimensional variations between the worn surface model and the nominal surface model, and generate a rebuild volume based on the trace data.

In yet another aspect of the present disclosure, a controller for selective tridimensional repair of a worn surface using at least a scanning device and an additive manufacturing device is provided. The controller may include a scanning module configured to generate point cloud data based on scan data obtained from the scanning device, an imaging module configured to generate a worn surface model of the worn surface based on the point cloud data and superimpose the worn surface module onto a nominal surface model, a trace module configured to generate trace data corresponding to dimensional variations between the worn surface model and the nominal surface model and generate a rebuild volume based on the trace data, and a rebuild module configured to operate the additive manufacturing device based on the rebuild volume.

### BRIEF DESCRIPTION OF THE DRAWINGS

FIG. 1 is a schematic illustration of one exemplary control system for performing a remanufacturing operation in accordance with the present disclosure;

FIG. 2 is a diagrammatic illustration of different stages involved in a remanufacturing operation performed in accordance with the present disclosure;

FIG. 3 is a pictorial illustration of one exemplary application of a remanufacturing operation of the present disclosure as applied to a piston head sample part;

FIG. 4 is a diagrammatic illustration of one exemplary controller that may be used to perform a remanufacturing operation in accordance with the present disclosure; and

FIG. 5 is a flowchart of one exemplary disclosed algorithm or method that may configure a controller to perform a remanufacturing operation in accordance with the present disclosure.

### DETAILED DESCRIPTION

Although the following sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent other than the language of the claims. To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

Referring now to FIG. 1, one exemplary vision-based control system 100 for performing selective tridimensional repairs using additive manufacturing is provided. More specifically, the control system 100 may be used to repair or remanufacture a sample part 102 having worn surfaces 104 with one or more defects 106 therein. As shown, the control system 100 may generally include one or more computing devices 108, or at least one or more controllers 110 and associated memory 112, that are configured to communicate with at least one scanning device 114 and at least one additive manufacturing device 116. The scanning device 114 may employ a high resolution scanning camera, or any other suitable vision-based device capable of scanning the sample part 102 and at least the worn surface 104 thereof. In particular, in one embodiment the scanning device 114 may employ a high resolution scanning camera, or any other suitable vision-based device which is configured to scan, identify or classify, detect, map and model the volume, profile, and locations of a defect 106, worn surface 104 (which can be relative to an unworn surface of a sample part 102), as well as three dimensional representations thereof. In an additional or alternative embodiment, the scanning device 114 may employ a high resolution scanning camera, or any other suitable vision-based device which is configured to scan, identify or classify, detect, map and model a plurality of other surface features of a sample part 102 including, but not limited to one or more of surface roughness, geometrical features, reference surfaces or features, identification features or other forms of indicia, the presence of foreign objects or buildup of foreign material, and cracks. At a minimum, the scanning device 114 may employ a sensor having, for example, a resolution that is capable of detecting the minimum tolerance specified by the associated engineering drawing for each scanned section of the sample part 102. In one example embodiment, the scanning device 114 may employ a sensor capable of at least detecting resolutions of approximately 0.005 mm. The additive manufacturing device 116 may employ a laser additive manufacturing device, or any other suitable device capable of machining, tooling, removing, cladding, depositing, or otherwise repairing the worn surface 104 of the sample part 102. While only one arrangement of the control system 100 is schematically provided in FIG. 1, it will be understood that other variations will be apparent to those of skill in the art.

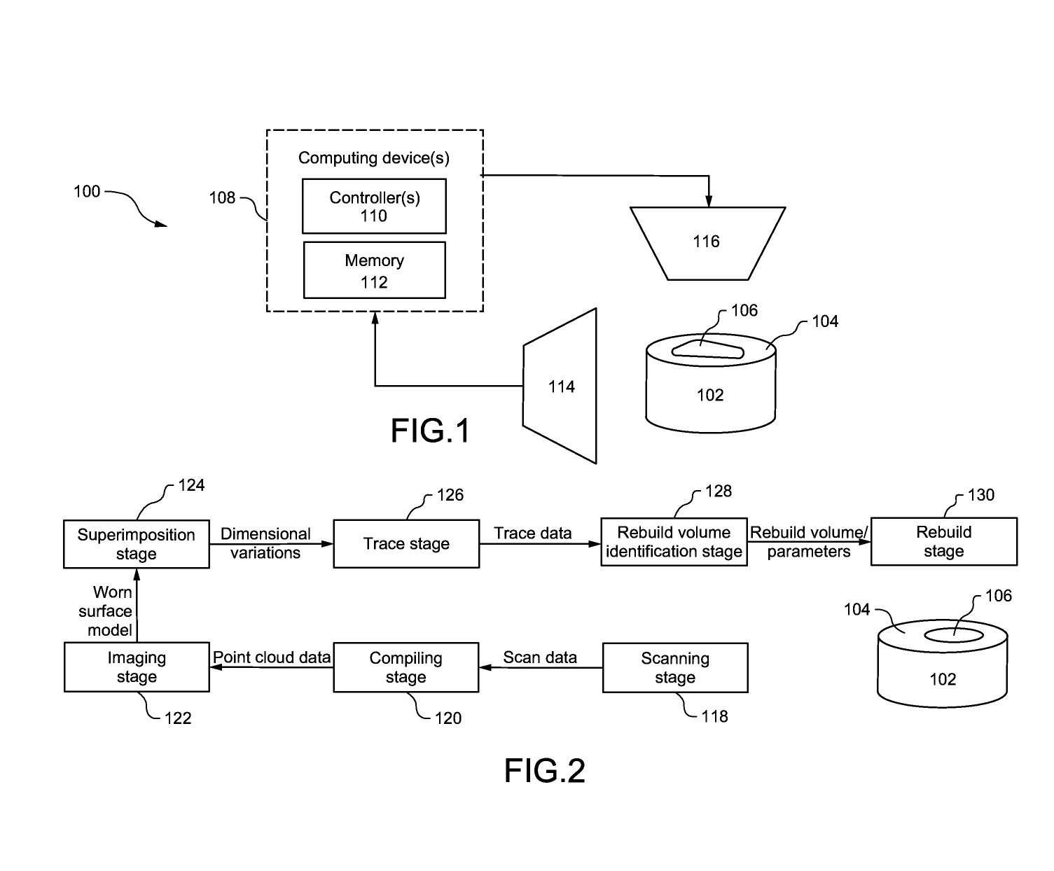

With further reference to FIG. 2, the different stages which may be involved in the operation of the control system 100 are diagrammatically provided. For example, in an initial scanning stage 118, the worn surface 104 and the sample part 102 may be scanned using a high resolution scanning camera 114, or the like, so as to obtain scan data. The scan data may include information capable of visually characterizing defects 106 in the worn surface 104 in terms of relative volume, depth, width, length, radius, circumference, surface area, spatial position, or any other parameter helpful in profiling the sample part 102. During a compiling stage 120, the scan data may be compiled to generate point cloud data. Specifically, relative volume and/or other profile information extracted from the scan data may be converted into discrete points spatially disposed within a three-dimensional coordinate system. Based on the point cloud data, the imaging stage 122 may generate a three-dimensional model of the worn surface 104 and digitally reconstruct the worn surface 104 of the original sample part 102 scanned during the scanning stage 118. In the superimposition stage 124, the digital model of the worn surface 104, or the worn surface model, may be superimposed onto a digital representation of a corresponding reference or nominal surface of the sample part 102, or a nominal surface model. The superimposition stage 124 may additionally be able to discern structural differences or dimensional variations between the worn surface model and the nominal surface model using any one or more of a variety of image processing techniques, such as heat images or color-coding schemes corresponding to depth measurements, or the like.

In the trace stage 126 of FIG. 2, the dimensional variations between the worn surface model and the nominal surface model may be traced to obtain trace data. The trace stage 126 may enable manual or visual tracing of the dimensional variations between the worn surface model and the nominal surface model, or alternatively, may automatically calculate and trace dimensional variations between the worn surface model and the nominal surface model. Moreover, the trace data may be used to obtain a three-dimensional outline of the worn surface 104 and the defects 106 therein, which can later be used to digitally model the rebuild volume. Based on the trace data, the rebuild volume identification stage 128 may digitally identify the localized rebuild volume within the worn surface 104 of the sample part 102 that needs repair. The rebuild volume identification stage 128 may additionally determine one or more parameters or instructions that are readable by the associated additive manufacturing device 116 and capable of controlling the additive manufacturing device 116 in a manner sufficient to perform actual repairs on the defects 106 within the worn surface 104 of the sample part 102. Finally, based on the rebuild volume parameters or instructions provided, the rebuild stage 130 may employ an additive manufacturing device 116, such as a laser additive manufacturing device, or the like, to perform the necessary repairs directly on the worn surface 104 of the sample part 102. Furthermore, subsequent scans of the sample part 102 may be intermittently performed after partial repairs and/or upon completion to verify that the repairs meet the desired specifications. If subsequent scans detect deviations or deficiencies in the repair, adjustments may be made to the rebuild volume parameters by repeating any one or more of the stages shown in FIG. 2 as needed.

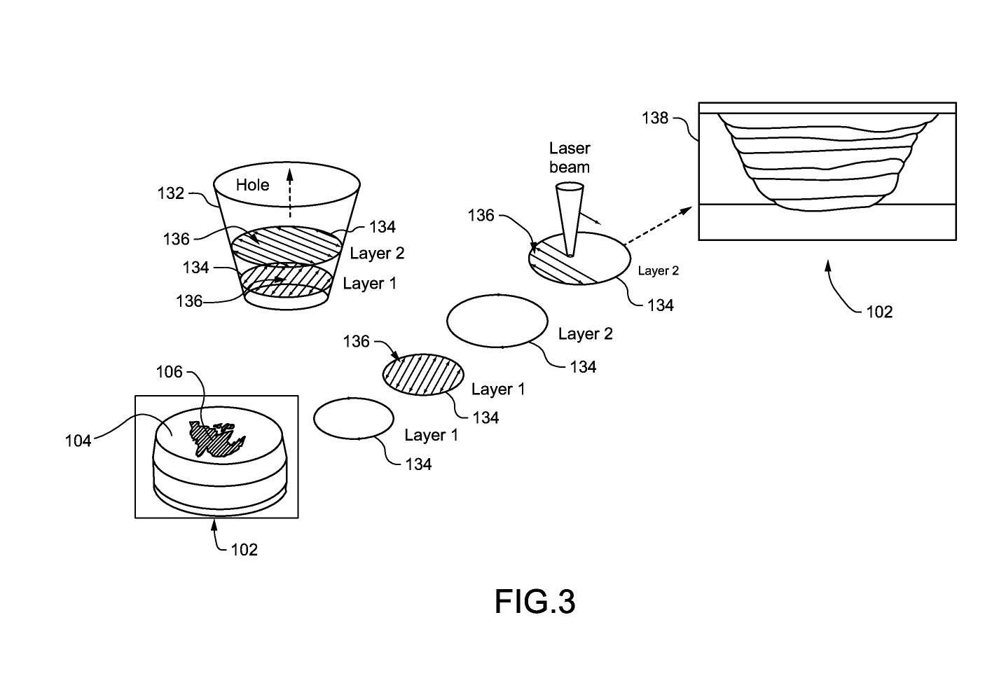

Turning now to FIG. 3, one such application of a control system 100 for repairing a worn surface 104 of a sample piston head 102 is diagrammatically illustrated. As shown, the worn surface 104 of the piston head 102 may include defects 106 requiring remanufacturing. Based on three-dimensional scanning and modeling of the worn surface 104, the control system 100 may be able to determine the minimum rebuild volume 132 that is needed to sufficiently repair all of the defects 106 within the piston head 102. Once the rebuild volume 132 has been determined, the relevant parameters or instructions for performing the rebuild may be determined in accordance with the rebuild volume 132. In the embodiment shown in FIG. 3, for example, the parameters may define dimensions and spatial positions of one or more layers 134 to be created within the worn surface 104, as well as the corresponding toolpaths 136 according to which the cladding, laser metal powder deposition, or any other additive manufacturing process should be applied. Moreover, the layers 134 and the toolpaths 136 may be constrained within and defined specifically according to the rebuild volume 132. Once the parameters are defined and exported, the associated additive manufacturing device 116 may perform the repairs for each layer 134 until the worn surface 104 is corrected as demonstrated for example by the remanufactured surface 138 of FIG. 3.

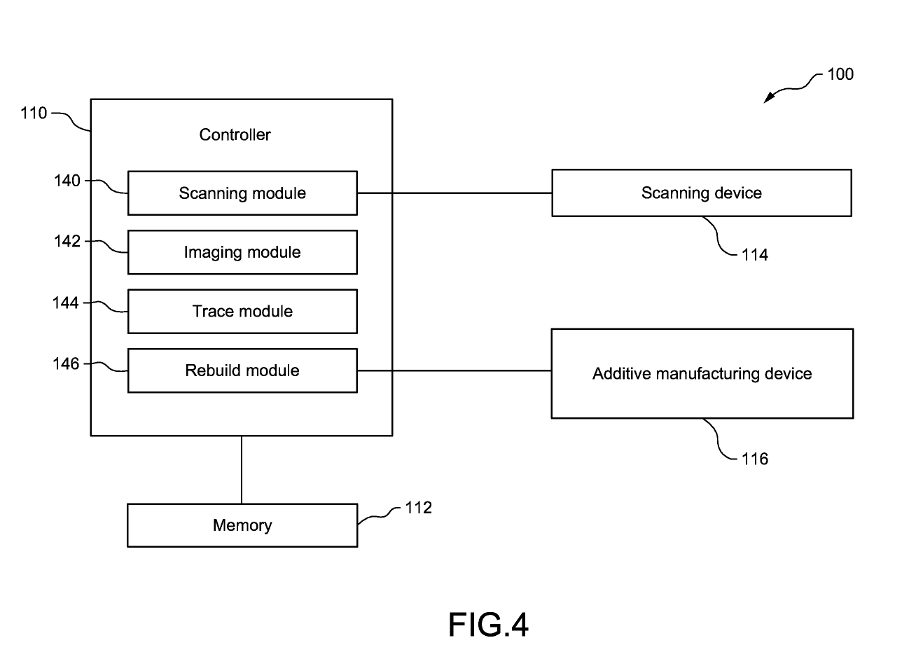

With further reference to FIG. 4, one exemplary embodiment of a control system 100 that may be used in conjunction with a scanning device 114 and an additive manufacturing device 116 to perform selective tridimensional repair of a worn surface 104 is schematically provided. As shown, the control system 100 may include, among other things, at least one controller 110 that is in communication with the scanning device 114, the additive manufacturing device 116 and associated memory 112. More specifically, the memory 112 may be provided on-board the controller 110, external to the controller 110, or otherwise in communication therewith. The memory 112 may further retrievably store one or more preprogrammed algorithms according to which the controller 110 may be configured to operate. The controller 110 may be implemented using any one or more of a processor, a microprocessor, a microcontroller, or any other suitable means for executing instructions stored within the memory 112. Additionally, the memory 112 may include non-transitory computer-readable medium or memory, such as a disc drive, flash drive, optical memory, read-only memory (ROM), or the like.

As shown in FIG. 4, the one or more controllers 110 of the control system 100 may be configured to operate according to one or more preprogrammed algorithms, which may essentially be categorized into, for example, a scanning module 140, an imaging module 142, a trace module 144, and a rebuild module 146. In general, the scanning module 140 may be configured to communicate with the associated scanning device 114 to generate point cloud data corresponding to the defects 106 within a worn surface 104 of a sample part 102. In particular, the scanning module 140 may receive scan data, or data obtained from a three-dimensional image, laser and/or profile scan of the sample part 102 using, for example, a high resolution scanning camera 114, or the like. The scan data may include information capable of defining the worn surface 104 in terms of relative depth, width, length, radius, circumference, surface area, spatial position, or the like. The scanning module 140 of the controller 110 may further be responsible for compiling the scan data to generate point cloud data corresponding to the worn surface 104, or one or more data sets which spatially define a plurality of points within a three-dimensional coordinate system.

Based on point cloud data, the imaging module 142 of the controller 110 of FIG. 4 may be configured to generate a worn surface model or a three-dimensional digital representation of the worn surface 104. The imaging module 142 may further have access to information pertaining to a nominal surface model or a three-dimensional digital representation of the undamaged surface that corresponds to the worn surface 104. Moreover, the nominal surface model may be derived based on information stored in the memory 112 and/or obtained from a direct scan of a nominal surface corresponding to the sample part 102. The imaging module 142 may additionally superimpose the worn surface model onto the nominal surface model, or vice versa, in a manner which substantially aligns the models in terms of relative depth, scale, position, orientation, spatial pose, or the like, such that only the defects 106 are visually distinguishable from the superimposed models. The imaging module 142 may accordingly obtain data pertaining to any dimensional variations between the worn surface model and the nominal surface model, and communicate such information to a trace module 144 of the controller 110. Moreover, the imaging module 142 may be configured to represent the dimensional variations between the superimposed models, for example, as one or more heat images capable of characterizing relative depth measurements in terms of a color-coded scheme, or the like.

The trace module 144 of FIG. 4 may be configured to generate trace data based on the dimensional variations between the worn surface model and the nominal surface model. The trace data may be derived based at least partially on manual traces of the dimensional variations between the worn surface model and the nominal surface model, and/or based on automatic calculations performed between the superimposed models. Specifically, the trace data may define the three-dimensional volume of material deficit that is caused by the defects 106 in the worn surface 104 and in need of repair. Based on such trace data, the rebuild module 146 may be able to determine the appropriate rebuild volume 132, or the volume of material within the worn surface 104 that will need repair or remanufacturing. In particular, the rebuild volume 132 may be defined as the minimum three-dimensional volume necessary to sufficiently encompass the defects 106 identified by the trace data. The rebuild module 146 may further be configured to operate the additive manufacturing device 116 based on the rebuild volume 132. For example, the rebuild module 146 may generate parameters including layers 134, toolpaths 136, or the like, that are capable of instructing the associated additive manufacturing device 116 to perform the necessary repairs on the worn surface 104 of the sample part 102 within the boundaries defined by the rebuild volume 132.

Other variations and modifications to the algorithms or methods employed to operate the control systems 100 and/or controllers 110 disclosed herein will be apparent to those of ordinary skill in the art. One exemplary algorithm or method by which the controller 110 may be operated, for instance to perform selective tridimensional repair of a worn surface 104 using a scanning device 114 and an additive manufacturing device 116, is discussed in more detail below.

### INDUSTRIAL APPLICABILITY

In general terms, the present disclosure sets forth systems and methods for performing selective remanufacture or repair operations where there are motivations to provide for better identification of defects and more streamlined integration between the identification and repair stages. Moreover, the present disclosure provides more intuitive vision-based procedures for identifying tridimensional defects within a worn surface, which operate in conjunction with tooling, machining, and/or additive manufacturing devices in a manner which improves overall efficiency and reduces complexity. The present disclosure may be particularly applicable to laser additive manufacturing operations, but may also be suited for use with any other comparable device capable of machining, tooling, removing, cladding, depositing, or the like. By providing more accurate and integral means for identifying defects, the present disclosure is able to perform repairs that are much more focused and substantially reduce the time and costs spent on the overall remanufacturing process.

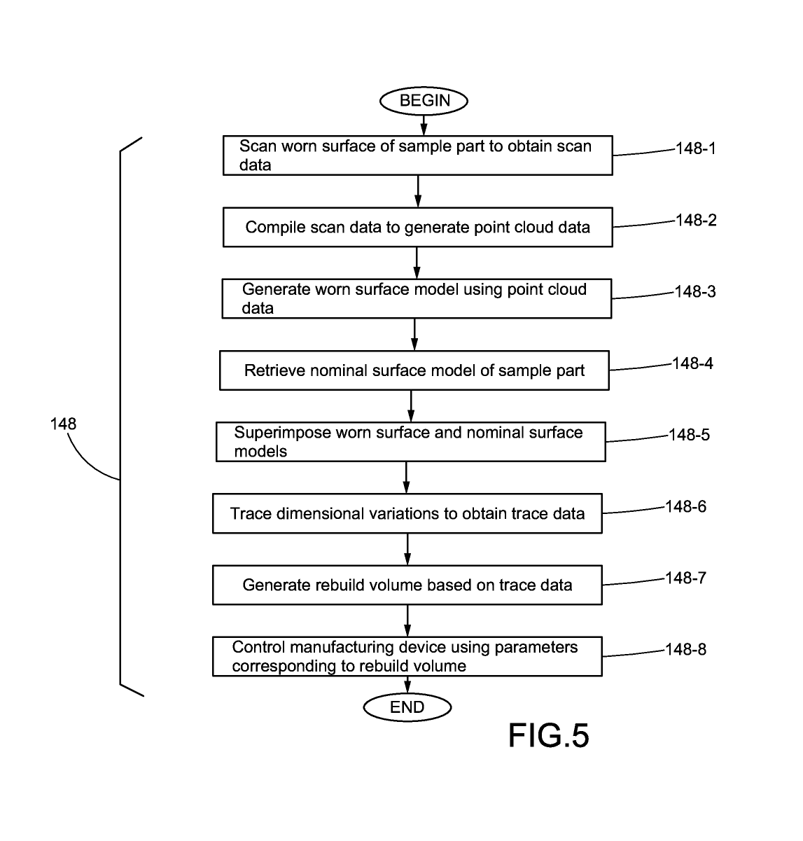

Referring now to FIG. 5, one exemplary algorithm or computer-implemented method 148 for performing selective tridimensional repair of a worn surface 104 using a scanning device 114 and an additive manufacturing device 116 is diagrammatically provided, according to which the control system 100 or the controller 110 thereof may be configured to operate. At the outset, the controller 110 according to block 148-1 may be configured to initiate a three-dimensional image scan of at least the worn surface 104 of a sample part 102. Specifically, the controller 110 may instruct or communicate with a vision-based scanning device 114, such as a high resolution scanning camera, or the like, to digitalize the worn surface 104 and the defects 106 therein, and to obtain scan data corresponding to the worn surface 104 and the defects 106. Moreover, the scan data may contain information capable of visually characterizing the worn surface 104 in terms of relative depth, width, length, radius, circumference, surface area, spatial position, or the like. In block 148-2, the controller 110 may be configured to compile the scan data received to extract point cloud data therefrom, or data sets spatially defining a plurality of points within a three-dimensional coordinate system corresponding to the worn surface 104 of the sample part 102.

Additionally, according to block 148-3 of FIG. 5, the controller 110 may be configured to generate a worn surface model, or a three-dimensional visual model of the worn surface 104 of the sample part 102. In particular, the controller 110 may be programmed to employ information contained within the point cloud data to digitally construct three-dimensional surfaces corresponding to the worn surface 104 scanned by the scanning device 114. Furthermore, the controller 110 in block 148-4 may be configured to retrieve or recall a nominal surface model that corresponds to the sample part 102. For example, the nominal surface model may include a three-dimensional digital representation of the undamaged surface of the sample part 102 corresponding to the worn surface 104. The controller 110 may retrieve information pertaining to the nominal surface model from external sources and/or recalled from information preprogrammed into the memory 112 associated therewith. Once both the worn surface model and nominal surface model are acquired, the controller 110 according to block 148-5 may be configured to superimpose the models onto one another such that the models are substantially aligned in terms of relative depth, scale, position, orientation, spatial pose, or the like.

Once adequate superimposition between the worn surface model and the nominal surface model is obtained, the controller 110 according to block 148-6 of FIG. 5 may be capable of isolating the volume of defects 106 in need of repair by tracing dimensional variations between the superimposed models. More particularly, the controller 110 may be programmed to enable manual and/or automated three-dimensional tracing of deviations between the volume defined by the worn surface model and the volume defined by the nominal surface model. In certain implementations, the dimensional variations may be distinguishable using color schemes, such as in heat images, or the like, or color-coded based on relative depth measurements within the worn surface 104. As dimensional variations between the superimposed models are traced, information relating to the traced volume, such as relative depth measurements, scale, position, orientation, spatial pose, or the like, may be collected by the controller 110 in the form of trace data and at least temporarily stored within the memory 112. Other modes of tracing dimensional variations and collecting trace data may also be implemented to produce comparable results and will be apparent to those of ordinary skill in the art.

In addition, once the trace data is sufficient to form at least one closed volume, the controller 110 according to block 148-7 of the method 148 of FIG. 5 may be configured to generate or define a rebuild volume 132, or the volume of material within the worn surface 104 to be repaired, based on the trace data. The rebuild volume 132 may be sufficiently sized to encompass the entirety of the dimensional variations, or the volume of defects 106 within the worn surface 104, as well as adequately shaped to facilitate tooling, machining, manufacturing, or other machine-guided repairs. The rebuild volume 132 may further be simultaneously constrained in size so as not to unnecessarily extend too far into undamaged or unaffected areas of the sample part 102. Furthermore, in accordance with block 148-8, the controller 110 may be configured to control or communicate the appropriate instructions to an associated additive manufacturing device 116, such as a laser additive manufacturing device, or the like, to perform the necessary repairs within the previously defined boundaries of the rebuild volume 132. Specifically, based on the rebuild volume 132, the controller 110 may be programmed to communicate the rebuild volume 132 in the appropriate format of parameters, layers and/or toolpaths that are readable by the associated additive manufacturing device 116 and capable of instructing the additive manufacturing device 116 to repair the worn surface 104 using any one or more of machining, tooling, removing, cladding, depositing, or the like.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

1. A computer-implemented method for selective tridimensional repair of a worn surface using at least a scanning device and an additive manufacturing device, comprising:
generating a worn surface model of the worn surface based on point cloud data obtained from the scanning device;
superimposing the worn surface model onto a nominal surface model;
generating trace data corresponding to dimensional variations between the worn surface model and the nominal surface model; and
generating a rebuild volume based on the trace data.

2. The computer-implemented method of claim 1, further comprising:
scanning the worn surface using the scanning device to obtain scan data; and
compiling the scan data to generate the point cloud data.

3. The computer-implemented method of claim 2, wherein the scanning device is a high resolution scanning camera.

4. The computer-implemented method of claim 1, wherein the dimensional variations between the worn surface model and the nominal surface model are represented as one or more heat images characterizing depth measurements in terms of a color scheme.

5. The computer-implemented method of claim 1, wherein the nominal surface model is predefined and obtained from an external source.

6. The computer-implemented method of claim 1, wherein the trace data is generated using an automated tracing process of the dimensional variations between the worn surface model and the nominal surface model.

7. The computer-implemented method of claim 1, further comprising:
operating the additive manufacturing device based on the rebuild volume.

8. The computer-implemented method of claim 7, wherein the rebuild volume is generated in terms of additive manufacturing parameters capable of instructing the additive manufacturing device to repair the worn surface.

9. The computer-implemented method of claim 7, wherein the additive manufacturing device is a laser additive manufacturing device.

10. A control system for selective tridimensional repair of a worn surface, comprising:
a scanning device configured to scan the worn surface;
an additive manufacturing device configured to repair the worn surface;
a memory configured to retrievably store one or more algorithms; and
a controller in communication with each of the scanning device, the additive manufacturing device, and the memory, and based on the one or more algorithms, configured to at least:
superimpose a worn surface model of the worn surface onto a nominal surface model,
generate trace data corresponding to dimensional variations between the worn surface model and the nominal surface model, and
generate a rebuild volume based on the trace data.

11. The control system of claim 10, wherein the scanning device is a high resolution scanning camera, and the additive manufacturing device is a laser additive manufacturing device.

12. The control system of claim 10, wherein the controller is further configured to receive scan data from the scanning device, compile the scan data, generate point cloud data based on the compiled scan data, and generate the worn surface model based on the point cloud data.

13. The control system of claim 10, wherein the controller is configured to represent the dimensional variations between the worn surface model and the nominal surface model as one or more heat images characterizing depth measurements in terms of a color scheme.

14. The control system of claim 10, wherein the controller is configured to retrieve the nominal surface model from information preprogrammed in the memory.

15. The control system of claim 10, wherein the controller is configured to generate the trace data based at least partially on an automated tracing process of the dimensional variations between the worn surface model and the nominal surface model.

16. The control system of claim 10, wherein the controller is configured to generate the rebuild volume in terms of additive manufacturing parameters capable of instructing the additive manufacturing device to repair the worn surface.

17. The control system of claim 10, wherein the controller is further configured to operate the additive manufacturing device based on the rebuild volume.

18. A controller for selective tridimensional repair of a worn surface using at least a scanning device and an additive manufacturing device, comprising:
a scanning module configured to generate point cloud data based on scan data obtained from the scanning device;
an imaging module configured to generate a worn surface model of the worn surface based on the point cloud data, and superimpose the worn surface model onto a nominal surface model;
a trace module configured to generate trace data corresponding to dimensional variations between the worn surface model and the nominal surface model, and generate a rebuild volume based on the trace data; and
a rebuild module configured to operate the additive manufacturing device based on the rebuild volume.

19. The controller of claim 18, wherein the scanning module is configured to compile the scan data obtained from a high resolution scanning camera, and generate the point cloud data based on the compiled scan data, and the imaging module is configured to represent the dimensional variations between the worn surface model and the nominal surface model as one or more heat images characterizing depth measurements in terms of a color scheme.

20. The controller of claim 18, wherein the trace module is configured to generate the trace data based at least partially on an automated tracing process of the dimensional variations between the worn surface model and the nominal surface model, and generate the rebuild volume in terms of laser additive manufacturing parameters.
